(19) United States
(12) Patent Application Publication
(10) Pub. No.: US 2008/0047021 A1
(43) Pub. Date: Feb. 21, 2008

(54) Personalized interactive communication method and system

(75) Inventor: Brijetta Lynn Hall, Chicago, IL (US)

Correspondence Address: Winstead Sechrest & Minick P.C., P.O. Box 50784, Dallas, TX, 75201, US

(73) Assignee: Metta Concepts, Inc., Frisco, TX (US)

(21) Appl. No.: 11/507,139

(22) Filed: Aug. 21, 2006

(51) Int. Cl. H04L 9/32; G06F 17/30; G06F 7/04; G06K 9/00; H03M 1/68; G06F 12/14; H04L 9/00; G06F 12/00; H04K 1/00; G06F 13/00; G06F 7/58; G06K 19/00; G11C 7/00; H04N 7/16

(52) U.S. Cl. 726/28; 713/182; 726/16

(57) ABSTRACT

An interactive communication apparatus, which connects to a computer, comprises an interactive communication device, having a tag, that is removably placed on or adjacent to an interactive communication device holder, having a sensor, wherein the tag communicates information to the sensor. The interactive communication system enables a user to transfer, store or retrieve information about and/or to a person that is identified with that interactive communication device. Once the interactive communication device is placed on or adjacent to the interactive communication device holder, certain communication applications, which include, photo slideshow, chat, e-mails, music, videos, and RSS feed, launch. The user can terminate the applications by removing the interactive communication device from the interactive communication device holder. The user can access content related to a new person by placing another interactive communication device, that corresponds to the new person, on or adjacent to the interactive communication device holder.

### FIELD OF THE INVENTION

The present invention relates generally to communication involving the transfer storage and retrieval of information and more particularly to a personalized interactive computer communication involving the transfer, storage and retrieval of information using a device and/or a device holder being linked to a computer, where once the device is placed on or near the device holder, at least one application is launched.

### BACKGROUND

The transfer, storage and retrieval of information was accomplished using mail, telephone, answering machines and fax machines. These methods are limited in the type of information capable of being transferred and in the delays involved. Telephones and answering machines can only transfer voice messages, while fax machines can only transfer written information. Mail is capable of transferring more types of information, such as pictures, sound clips in the form of audio tapes and compact discs, and video in the form of VCR tapes and DVDs. However, mail is not an immediate transfer of information which many businesses and individuals desire. Computer networks, such as the Internet, helped solve some of the deficiencies presented by the older forms of communication. The Internet is extensively used for the immediate retrieval, storage and transfer of information from one or more users to another one or more users. Person to person communication, via e-mail or instant text messaging, can be accomplished using the Internet. Users can also transfer data files, pictures, music video and various other types of information via the Internet. There are many users, such as the very young children, the elderly people and some that are in between, that are uncomfortable using computers to communicate and thus are not able to take advantage of recent technological communication developments. Many people believe that it is too complicated and/or not as fun to communicate using the computer. There are also some people who choose not to communicate via the computer because it is too impersonal.

It is a desire of the present invention to provide a personalized interactive communication device that is easy, fun to use, interactive and minimizes the number of running windows that clutter the desktop.

### BRIEF SUMMARY OF THE INVENTION

An embodiment of the personalized interactive communication system for use with a computer includes a device holder having a sensor and a device having a tag. The device is capable of being removably placed onto the device holder. Once the tag is within a certain distance of the sensor, the sensor can either receive or read identifying information from the tag and then relay that identifying information to a mini-program within a computer, which launches at least one of a plurality of applications. These plurality of applications include, but are not limited to, a photo application, an e-mail application, a chat application, a music application, a video application, a RSS feed application, a calendar application, a web-browser application and an aggregator application.

The device is meant to be associated with a person that a user can communicate with. Each person will be associated with a different device. The device can be themed and/or be a figurine or doll with a picture frame and a picture of the person or a digital representation of the person, which can be a picture or a name; thereby making the communication experience interactive. A themed device may be a skier, a football player, a ballerina, an animal figurine or anything that reminds the user of the person. A user can customize the plurality of applications so that only certain ones will be launched when the device is on or near the device holder. The user will be able to associate certain e-mails, pictures, videos, music, RSS feed and calendar events that remind the user of the person, to the device. Additionally, if the computer is connected to the network, the user will have access to certain e-mails, pictures, videos, music, RSS feed and calendar events that the person has associated with the device.

The foregoing has outlined the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

The foregoing and other features and aspects of the present invention will be best understood with reference to the following description of a specific embodiment of the invention, when read in conjunction with the accompanying drawings, wherein:

FIG. 1 illustrates a personalized interactive communication system in accordance with one embodiment of the present invention;

FIG. 2 depicts a front view of a personalized interactive communication device in accordance with one embodiment of the present invention;

FIG. 3 illustrates several frames of a graphical user interface (GUI) in accordance with one embodiment of the present invention;

FIG. 4 depicts the various types of information that can be communicated in accordance with one embodiment of the present invention; and

FIG. 5 depicts a flow chart showing the operational method in accordance with one embodiment of the present invention.

### DETAILED DESCRIPTION

The following discussion is presented to enable a person skilled in the art to make and use the invention. The general principles described herein may be applied to embodiments and applications other than those detailed below without departing from the spirit and scope of the present invention as defined by the appended claims. The present invention is not intended to be limited to the embodiments shown, but is to be accorded the widest scope consistent with the principles and features disclosed herein.

As such, those skilled in the art will appreciate that the conception, upon which this disclosure is based, may readily be utilized as a basis for the designing of other structures, methods, and devices for carrying out the several purposes of the present invention. It is important, therefore, that the claims be regarded as including such equivalent constructions insofar as they do not depart from the spirit and scope of the present invention.

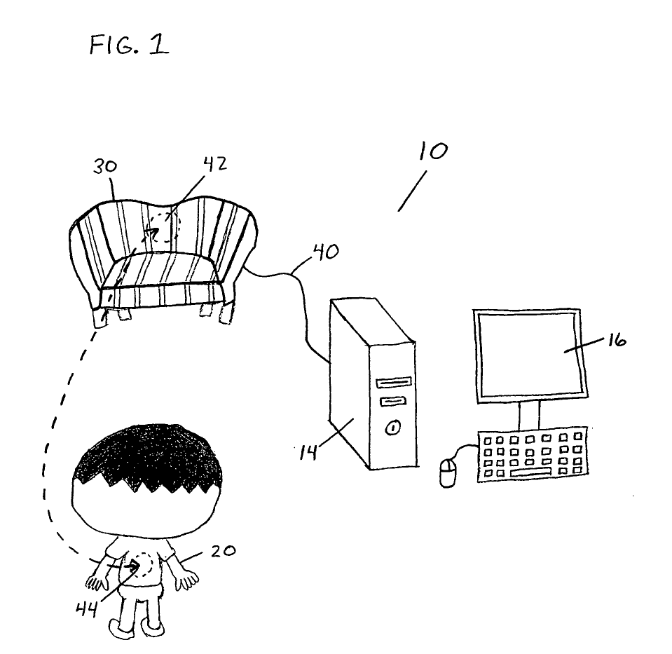

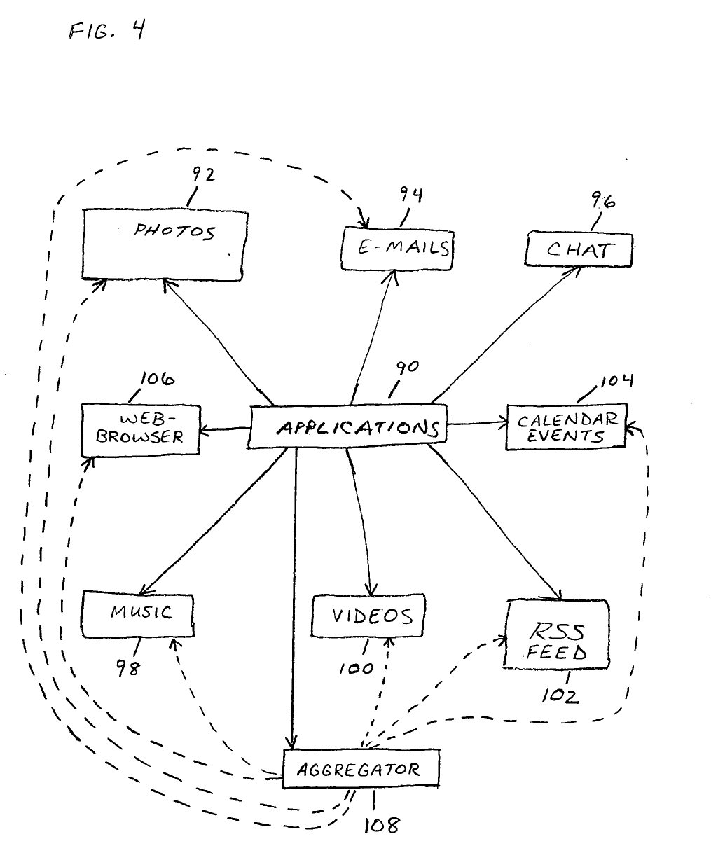

As shown in FIG. 1, the present invention disclosed hereinbelow describes a personalized interactive communication system 10 and device 20 specifically designed to make computer communication and information transfer, storage and retrieval more interactive, user-friendly, personal and fun. The personalized interactive communication system 10 includes an interactive communication device holder 30 having a sensor 42, a cable 40 that can connect the interactive communication device holder 30 to a computer 14 having a display screen 16 where the computer 14 is capable of connecting to the Internet, an interactive communication device 20 having a tag 44, wherein the interactive communication device 20 can be removably placed on or adjacent to the interactive communication device holder 30 such that the tag 44 is adjacent to the sensor 42, and a software loaded in the computer 14 for recognizing the tag 44 of the interactive communication device 20 and ultimately launching at least one application 90 (FIG. 4).

In an embodiment, the cable 40 is a USB cable. Although the embodiment depicts the interactive communication device holder 30 being connected to the computer 14 by the USB cable 40, the interactive communication device holder 30 may be connected to the computer 14 by other cabled methods or wireless methods without departing from the scope and spirit of the present invention. Also, although the preferred embodiment depicts the interactive communication device holder 30 being connected to the computer 14 by the USB cable 40, the interactive communication device 20, in lieu of the interactive communication device holder 30, may be connected to the computer 14 by cabled methods or wireless methods without departing from the scope and spirit of the present invention; thus eliminating the necessity for the interactive communication device holder 30, the sensor 42 and the tag 44.

The interactive communication device holder 30 is shown to be a chair having the sensor 42 installed within it. The sensor 42 is positioned so that it may receive or read identifying information from the interactive communication device's 20 tag 44, once the interactive communication device 20 is placed on or near the interactive communication device holder 30. Although this embodiment depicts the interactive communication device holder 30 being a chair, the interactive communication device holder 30 may be any platform, cradle or miniature object, such as a sofa, a bean bag, a surfboard, a stage, a simple stand, et cetera, that is capable of positioning the interactive communication device's 20 tag 44 next to the interactive communication device holder's 30 sensor 42 without departing from the scope and spirit of the present invention.

In this embodiment, the sensor 42 is capable of receiving or reading identifying information from the tag 44 when it is within 3 inches of each other. The sensor's 42 information receiving range may be greater than, equal to, or less than 3 inches without departing from the scope and spirit of the present invention. The sensor may be an IR sensor or an RF sensor. For this embodiment, the sensor 42 is concealed within the interactive communication device holder 30. The sensor 42 can still read identifying information from the tag 44, even though there is an obstruction between the sensor 42 and the tag 44. Although it is shown that the sensor 42 is concealed within the interactive communication device holder 30, the sensor 42 may be installed in the interactive communication device holder 30 with its surface exposed without departing from the scope and spirit of the present invention.

The interactive communication device holder 30 and the interactive communication device 20 can be constructed from any material or combination of materials, which includes vinyls, woods, metals, fabrics, and plastics, but are not limited exclusively to these materials. Any material capable of having the sensor 42 or tag 44 installed within it or placed on it, may be used to construct the interactive communication device holder 30 or the interactive communication device 20 without departing from the scope and spirit of the present invention.

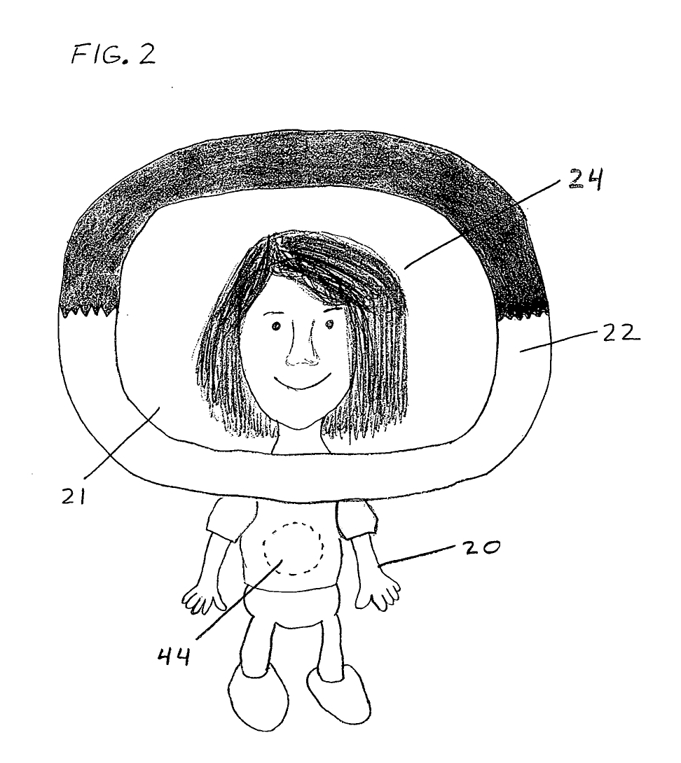

As shown in FIG. 2, the interactive communication device 20 is shown to be a figurine having the tag 44 installed within it, such that the tag 44 is positioned accordingly so that it may communicate identifying information to the interactive communication device holder's 30 (FIG. 1) sensor 42 (FIG. 1), once the interactive communication device 20 is placed on or near the interactive communication device holder 30 (FIG. 1). The tag 44 contains identifying information which may be an electronic unit capable of transmitting identifying information to the sensor 42 (FIG. 1) or it can be as simple as a bar code, where the sensor 42 (FIG. 1) can read the identifying information from the tag 44. Although this embodiment depicts the interactive communication device 20 being a figurine, the interactive communication device 20 may be any item, including dolls, action figures, miniature sporting equipment, pencils, books, et cetera, that is capable of positioning the interactive communication device's 20 tag 44 next to the interactive communication device holder's 30 (FIG. 1) sensor 42 (FIG. 1) without departing from the scope and spirit of the present invention. The interactive communication device 20 and the interactive communication device holder 30 (FIG. 1) may be a themed combination. For example, the interactive communication device 20 may be a miniature skier and the interactive communication device holder 30 (FIG. 1) may be a set of skis. Another example includes the interactive communication device 20 being a figurine with an enclosed photo in a frame sitting on a simple platform.

In this embodiment, the tag 44 is capable of sending/displaying identifying information to/for the sensor 42 (FIG. 1) when it is within 3 inches of each other. The tag 44 may have an infonnation sending range greater than, equal to, or less than 3 inches without departing from the scope and spirit of the present invention. The tag 44 is concealed within the interactive communication device 20. The tag 44 can still send identifying information to the sensor 42 (FIG. 1), even though there may be an obstruction between the tag 44 and the sensor 42 (FIG. 1). Although this embodiment shows that the tag 44 is concealed within the interactive communication device 20, the tag 44 may be installed in the interactive communication device 20 with its surface exposed without departing from the scope and spirit of the present invention.

Interactive communication device 20 also contains a person identifier 21. In the present embodiment, the person identifier 21 is a picture frame 22 having a picture 24. The picture 24 personalizes the interactive communication device 20 and is placed within the picture frame 22. In this embodiment, the picture frame 22 is located as the interactive communication device's 20 head. Although this embodiment depicts the picture frame 22 being located as the interactive communication device's 20 head, the picture frame 22 may be located anywhere on the interactive communication device 20, including the body, without departing from the scope and spirit of the present invention. The person identifier 21 may also be a digital representation, that can be downloaded into the interactive communication device 20, which may be a digital photo or a digitized name. Although this embodiment shows a picture 24 and picture frame 22 located on the interactive communication device 20, the interactive communication device 20 may not have the picture 24 and the picture frame 22 installed within it, but rather some other feature, i.e. a digital representation, to personalize the interactive communication device 20, without departing from the scope and spirit of the present invention.

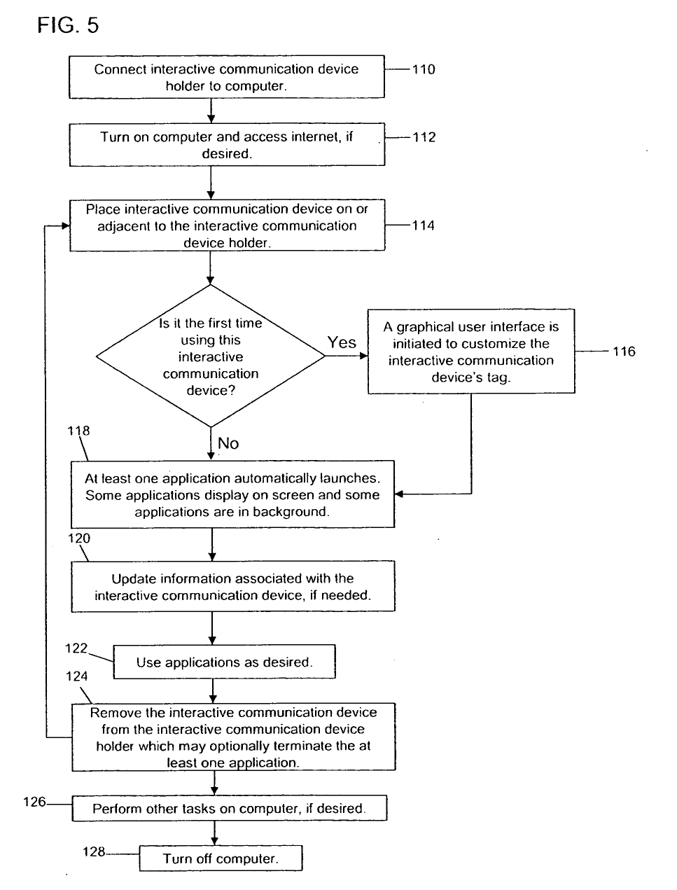

As illustrated in FIG. 5, the personalized interactive communication system's 10 (FIG. 1) operational method is described in a flowchart according to one embodiment of the present invention. First, the user should connect the interactive communication device holder 30 (FIG. 1) to the computer 14 (FIG. 1) 110, either by cabled or wireless methods. The user should then turn on the computer 14 (FIG. 1) and access the Internet, if desired 112. The computer 14 (FIG. 1) will usually recognize the new device and prompt the user for automatic installation and computer configuration. Although this operation method depicts connecting the interactive communication device holder 30 (FIG. 1) prior to turning on the computer 14 (FIG. 1), the computer 14 (FIG. 1) may be turned on prior to connecting the interactive communication device holder 30 (FIG. 1) to the computer 14 (FIG. 1) without departing from the scope and spirit of the present invention.

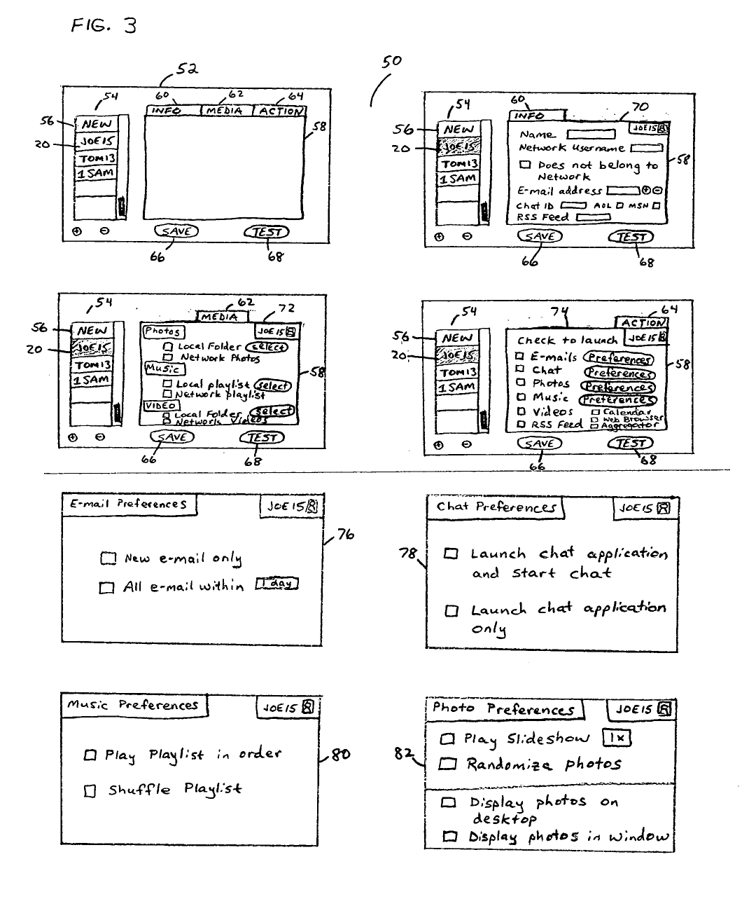

Continuing to reference FIG. 5, the interactive communication device 20 (FIG. 1) is placed on or adjacent to the interactive communication device holder 30 (FIG. 1) 114, such that the tag 44 (FIG. 1) is adjacent to the sensor 42 (FIG. 1) and identifying information can be relayed from the tag 44 (FIG. 1) to the sensor 42 (FIG. 1). Each tag 44 (FIG. 1) has a unique number associated with it. If this is the first time placing this particular interactive communication device 20 (FIG. 1) on or adjacent to the interactive communication device holder 30 (FIG. 1), the computer 14 (FIG. 1) will not recognize the interactive communication device's 20 (FIG. 1) tag 44 (FIG. 1) and will initiate a graphical user interface 50 (“GUI”) (FIG. 3) so that the interactive communication device's 20 (FIG. 1) tag 44 (FIG. 1) can be customized and recognized for future uses 116.

FIG. 3 illustrates several screenshots of the GUI 50 in accordance with one embodiment of the present invention. The first screenshot 52 shown in the top left is a graphical user interface main screen 52. The graphical user interface main screen 52 illustrates an interactive communication device list 54 that displays the interactive communication devices 20 the computer 14 (FIG. 1) already recognizes along with a new button 56 and a properties window 58 having an info tab 60, a media tab 62 and an action tab 64 for displaying relevant options respective to the interactive communication device 20 or new button 56 selected from the interactive communication device list 54. The user may select options for the interactive communication device 20 that is being used for the first time by ensuring that the new button 56 is highlighted within the interactive communication device list 54 and supplying and/or selecting the relevant information or options desired in the info tab 60, the media tab 62 and the action tab 64. Similarly, the user may change options for the interactive communication device 20 already recognized by the computer 14 (FIG. 1) by ensuring that the corresponding interactive communication device 20 is highlighted within the interactive communication device list 54 and changing the relevant information or options desired in the info tab 60, the media tab 62 and the action tab 64. A save button 66 is provided to save the information and options selected for the interactive communication device 20. A test button 68 is provided to test the selected interactive communication device 20.

Once the user clicks on the info tab 60, the info tab screen 70 appears in the properties window 58. Within the info tab screen 70, the user will need to enter information for the identification of the person the interactive communication device 20 is to be associated with, the network user name for the person associated with the interactive communication device 20, the e-mail address or addresses for the person associated with the interactive communication device 20, the chat ID along with the program that the chat ID is associated with for the person the interactive communication device 20 is to be associated with and the RSS feed for the person associated with the interactive communication device 20. The user will also need to identify whether the interactive communication device 20 will belong to the network. If the interactive communication device 20 belongs to the network, the user will be able to access information, including photos, music, video, et cetera, that the person associated with the interactive communication device 20 has uploaded onto the network or the user has uploaded to the network. The person associated with the interactive communication device 20 will be able to upload information and specify whether the information is for private viewing or public viewing. However, the information that the user uploads will be available only to the user. Although this embodiment specifies who may view certain information that has been uploaded onto the internet, either by the person associated with the interactive communication device 20 or by the user, this viewing may be altered without departing from the scope and spirit of the present invention. Also, although this embodiment only shows AOL and MSN as the chat programs available, other chat programs that exit now or in the future may be provided in the GUI 50 as additional chat program alternatives without departing from the scope and spirit of the present invention.

Once the user clicks on the media tab 62, the media tab screen 72, which is shown in the middle left, appears in the properties window 58. Within the media tab screen 72, the user will need to select photo files, music files and/or video files to be associated with the interactive communication device 20 and indicate whether these files be stored either locally within the computer 14 (FIG. 1) or by network. The music files can be music that the person associated with the interactive communication device 20 likes or music that reminds the user of the person associated with the interactive communication device 20.

Once the user clicks on the action tab 64, the action tab screen 74, which is shown in the middle right, appears in the properties window 58. Within the action tab screen 74, the user will need to select at least one application 90 to be launched for this interactive communication device 20. These applications 90, which are illustrated in FIG. 4, include photos 92, e-mails 94, chat 96, music 98, videos 100, RSS 102, calendar 104, web-browser 106 and aggregator 108. Although this embodiment shows the applications to be photos 92, e-mails 94, chat 96, music 98, videos 100, RSS 102, calendar 104, web-browser 106 and aggregator 108, other applications can be added or existing ones can be removed without departing from the scope and spirit of the present invention.

Once the user clicks on the preferences button for e-mail 94, the e-mail preferences window 76 appears. The user should indicate whether he wishes to see new e-mails only or e-mails within a certain time period that were sent to or received from the person associated with the interactive communication device 20. The time periods shown in this embodiment are one day, two days, one week, two weeks, one month, one year and entire time. Although this embodiment shows time periods of one day, two days, one week, two weeks, one month, one year and entire time, other time periods that are shorter, longer, or in between may be available as other options without departing from the scope and spirit of the present invention. Once the user clicks on the preferences button for chat 96, the chat preferences window 78 appears. The user should indicate whether he wishes to launch the chat 96 application only or launch the chat 96 application and start a chat with the person associated with the interactive communication device 20. Once the user clicks on the preferences button for music 98, the music preferences window 80 appears. The user should indicate whether he wishes to play the music play list in order or shuffle the music play list. Once the user clicks on the preferences button for photo 92, the photo preferences window 82 appears. The user should indicate whether he wishes to play the photos, in a slideshow format, in order a certain number of times, where this embodiment has 1×, 2×, 3×, or loop mode options, or whether to display the photos, in a slideshow format, in a random order. Also, the user should indicate whether the photos should display on the entire display screen 16 (FIG. 1) or in a separate window within the display screen 16 (FIG. 1). It is envisioned that the user will also be able to control the time delay between the displaying of different photos. Although this embodiment shows certain preferences that can be controlled by the user, other preferences may also be controlled by the user without departing from the scope and spirit of the present invention.

Although this embodiment depicts the GUI 50 as illustrated in FIG. 4, other GUIs may be used without departing from the scope and spirit of the present invention. This

GUI 50 is used for illustration purposes only and does not in any way limit the scope of the present invention. Once the user clicks on the save button 66, the GUI 50 creates a mini-program (not shown) for the specific interactive communication device's 20 tag 44 (FIG. 1). In this embodiment, the mini-program is written in Apple Script. Although this embodiment shows the mini-program to be written in Apple Script, the mini-program can be written for any computer platform and in any compatible language without departing from the scope and spirit of the present invention.

Referring back to FIG. 5, once the interactive communication device's 20 (FIG. 1) tag 44 (FIG. 1) has been configured for the first time, the operation will be the same as if the computer 14 (FIG. 1) had recognized the interactive communication device's 20 (FIG. 1) tag 44 (FIG. 1), after it was placed on or adjacent to the interactive communication device holder's 30 (FIG. 1) sensor 42 (FIG. 1). Once the computer 14 (FIG. 1) recognizes the interactive communication device's 20 (FIG. 1) tag 44 (FIG. 1), the software (not shown) is launched. In this embodiment the software is written in Java language. Although this embodiment shows the software to be written in Java language, the software can be written for any computer platform and in any compatible language without departing from the scope and spirit of the present invention. The software then searches for the mini-program that is associated with the interactive communication device's 20 (FIG. 1) tag 44 (FIG. 1) and launches it.

The mini-program, which has the user's preferences, then launches the desired applications 90 (FIG. 4) associated with this interactive communication device's 20 (FIG. 1) tag 44 (FIG. 1) 118. If all applications 90 (FIG. 4) were desired to be launched, the mini-program first launches an application 90 (FIG. 4) capable of playing music 98 (FIG. 4) and begins playing the music play list associated with the interactive communication device's 20 (FIG. 1) tag 44 (FIG. 1). The application 90 (FIG. 4) capable of playing music 98 (FIG. 4) will be launched in the background so that a separate window does not open and there is less clutter on the desktop. Although this embodiment shows that the application 90 (FIG. 4) capable of playing music 98 (FIG. 4) will be launched in the background, the application 90 (FIG. 4) capable of playing music 98 (FIG. 4) may be launched on the desktop in a separate window without departing from the scope and spirit of the present invention. The music play list can be stored locally within the computer 14 (FIG. 1) or on the network. If the music play list is stored on the network, the person associated with the interactive communication device 20 (FIG. 1) may periodically update the contents in the music play list so that the contents are current. In this embodiment, the software capable of playing music 98 (FIG. 4) is i-tunes.

Although this embodiment shows i-tunes as the application 90 (FIG. 4) capable of playing music 98 (FIG. 4), any application 90 (FIG. 4) capable of playing music 98 (FIG. 4) can be used without departing from the scope and spirit of the present invention.

The mini-program then launches an application 90 (FIG. 4) capable of creating the chat 96 (FIG. 4) and may initiate the chat 96 (FIG. 4) with the person associated with the interactive communication device 20 (FIG. 1), depending upon the user's preferences. The chat 96 (FIG. 4) would be initiated only if the person associated with the interactive communication device 20 (FIG. 1) is on-line. In this embodiment, the application 90 (FIG. 4) capable of creating the chat 96 (FIG. 4) is i-chat. Although this embodiment shows i-chat as the application 90 (FIG. 4) capable of creating the chat 96 (FIG. 4), any application 90 (FIG. 4) capable of creating the chat 96 (FIG. 4) can be used without departing from the scope and spirit of the present invention.

The mini-program then launches an application 90 (FIG. 4) capable of sending, receiving and viewing sent and received e-mails 94 (FIG. 4). E-mails 94 (FIG. 4) related to the person associated with the interactive communication device 20 (FIG. 1) are displayed according to the preferences selected by the user.

The mini-program then launches an application 90 (FIG. 4) capable of viewing photos 92 (FIG. 4) via a slideshow. Photos 92 (FIG. 4) related to the person associated with the interactive communication device 20 (FIG. 1) are displayed according to the preferences selected by the user. The photo files can be stored locally within the computer 14 (FIG. 1) or on the network. If the photo files are stored on the network, the person associated with the interactive communication device 20 (FIG. 1) may periodically update the contents of the photo files so that the contents are current.

The mini-program then launches an application 90 (FIG. 4) capable of viewing videos 100 (FIG. 4). Videos 100 (FIG. 4) related to the person associated with the interactive communication device 20 (FIG. 1) are displayed according to the preferences selected by the user. The video files can be stored locally within the computer 14 (FIG. 1) or on the network. If the video files are stored on the network, the person associated with the interactive communication device 20 (FIG. 1) may periodically update the contents of the video files so that the contents are current.

The mini-program then launches an application 90 (FIG. 4) capable of downloading RSS feed 102 (FIG. 4). RSS feed 102 (FIG. 4) related to the person associated with the interactive communication device 20 (FIG. 1) are displayed according to the preferences selected by the user. The RSS feed 102 (FIG. 4) can contain various information including personal blogs.

The mini-program then launches an application 90 (FIG. 4) capable of viewing calendar events 104 (FIG. 4). Calendar events 104 (FIG. 4) related to the person associated with the interactive communication device 20 (FIG. 1) are displayed according to the preferences selected by the user. These preferences may include events within the next day, the next week, the next month, et cetera. The events can be stored locally within the computer 14 (FIG. 1) or on the network. If the events are stored on the network, the person associated with the interactive communication device 20 (FIG. 1) may periodically update the contents of the events so that the contents are current.

If the web-browser 106 option was selected during the configuration of the interactive communication device 20, the mini-program would launch the web-browser 106 which then interfaces with existing web applications that relate to personal infonnation, such as MySpace and Facebook. The web-browser 106 then communicates the essential infonnation found on the existing web applications to the user.

Finally, if the aggregator 108 option was selected during the configuration of the interactive communication device 20, the mini-program would launch the aggregator 108 which then aggregates the essential infonnation stored within the e-mail application 94, photo application 92, video application 100, music application 98, RSS feed application 102, calendar event application 104 and web-browser application 106 and/or downloads the essential information from the internet. The aggregator 108 then communicates the aggregated essential infonnation to the user.

Although this embodiment depicts a particular order for launching applications 90 (FIG. 4), the applications 90 (FIG. 4) may launch in any order without departing from the scope and spirit of the present invention. It is also envisioned that the user will have the ability to control the order of launching the various applications 90 (FIG. 4).

Once the desired applications 90 (FIG. 4) launch, the user will be able to update infonnation and options related to the interactive communication device 20 (FIG. 1) 120 by clicking on a GUI icon (not shown), which, in the present embodiment, will be located on the lower right side of the display screen 16 (FIG. 1). Although this embodiment depicts the GUI icon being located on the lower right side of the display screen 16 (FIG. 1), the GUI icon may be placed anywhere on the display screen 16 (FIG. 1) without departing from the scope and spirit of the present invention. Also, although this embodiment depicts a GUI icon, the GUI icon may be absent from the display screen 16 without departing from the scope and spirit of the present invention.

Once the desired applications 90 (FIG. 4) launch, the user can use the applications 90 (FIG. 4) as desired until the user is ready to terminate the applications 90 (FIG. 4) 122. In this embodiment, the user may terminate the applications 90 (FIG. 4) by removing the interactive communication device 20 (FIG. 1 ) a certain distance away from the interactive communication device holder 30 (FIG. 1), so that the tag 44 (FIG. 1) can no longer communicate identifying information to the sensor 42 (FIG. 1) 124. The user can then place another interactive communication device 20 (FIG. 1), having a different unique number, on or adjacent to the interactive communication device holder 30 (FIG. 1), thus starting the desired applications 90 (FIG. 4) associated with that interactive communication device's 20 (FIG. 1) tag 44 (FIG. 1). Alternatively, the user can start performing other tasks on the computer 14 (FIG. 1) 126 or simply turn off the computer 14 (FIG. 1) 128 if the user has no other tasks to perform. In another embodiment of this invention, the user has the option as to whether the applications 90 will automatically terminate once the interactive communication device 20 (FIG. 1) has been moved a certain distance away from the interactive communication device holder 30 (FIG. 1). In this second embodiment, the applications 90 will continue to run, but the information displayed will be updated once a new interactive communication device 20 (FIG. 1) has been moved within a certain distance of the interactive communication device holder 30 (FIG. 1).

In an alternative embodiment, the interactive communication device holder 30 (FIG. 1) may be designed to have multiple sensors 42 (FIG. 1) so that more than one interactive communication device 20 (FIG. 1) can be placed on or adjacent to the interactive communication device holder 30 (FIG. 1) simultaneously. Thus, once all the applications 90 (FIG. 4) have been launched, the user will be able to initiate the chat 96 (FIG. 4) with all the people associated with each of the interactive communication devices 20 (FIG. 1) simultaneously. Also, the music 98 (FIG. 4), videos 100 (FIG. 4), RSS feed 102 (FIG. 4), photos 92 (FIG. 4) and e-mails 94 (FIG. 4) associated with each of the interactive communication device 20 (FIG. 1) will be played or displayed continuously. Once the user wishes to terminate a person from the chat 96 (FIG. 4) or other applications 90 (FIG. 4), the user only needs to remove the interactive communication device 20 (FIG. 1) associated with the person that is desired to be removed from the interactive communication device holder 30 (FIG. 1).

Although the invention has been described with reference to specific embodiments, these descriptions are not meant to be construed in a limiting sense. Various modifications of the disclosed embodiments, as well as alternative embodiments of the invention will become apparent to persons skilled in the art upon reference to the description of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. It is therefore, contemplated that the claims will cover any such modifications or embodiments that fall within the true scope of the invention.

What is claimed is:

1. A method for using a personalized interactive communication system that uses a computer, the method comprising the steps of:
connecting an interactive communication device holder to the computer;
placing an interactive communication device, having a person identifier, on or adjacent to the interactive communication device holder, wherein the interactive communication device is associated with a person via the person identifier;
having a plurality of applications automatically launch, wherein the plurality of applications is selected from the group consisting of a photo application, an e-mail application, a chat application, a music application, a video application, a RSS feed application, a calendar event application, a web-browser application and an aggregator; and
allowing a user to use the plurality of applications.

2. The method of claim 1 further comprising the step of allowing the user to access a graphical user interface for customizing the plurality of applications associated with the interactive communication device.

3. The method of claim 1 further comprising the step of allowing the user to determine whether the plurality of applications should terminate when the interactive communication device is removed from the interactive communication device holder.

4. The method of claim 1 wherein the interactive communication device holder is a platform, cradle or miniature object.

5. The method of claim 1 wherein the interactive communication device is a figurine, an action figure, a doll, a miniature sporting equipment, a pencil or a book.

6. The method of claim 1 wherein the person identifier is a photo frame having a picture of the person associated with the interactive communication device.

7. The method of claim 1 wherein the person identifier is a digital representation.

8. The method of claim 1 wherein the photo application is associated with a plurality of photo files that relate to the person, wherein the plurality of photo files are displayed as a slideshow.

9. The method of claim 8 wherein the computer is connected to the Internet.

10. The method of claim 9 wherein the person may update the plurality of photo files on the Internet.

11. The method of claim 1 wherein the e-mail application displays any e-mail the user sent to or received from the person within a specified time period.

12. The method of claim 1 wherein the music application is associated with a plurality of music files.

13. The method of claim 12 wherein the plurality of music files contains music the person likes.

14. The method of claim 12 wherein the plurality of music files contains music that reminds the user of the person.

15. The method of claim 12 wherein the computer is connected to the Internet.

16. The method of claim 15 wherein the person may update the plurality of music files on the Internet.

17. The method of claim 1 wherein the interactive communication device and the interactive communication device holder are a themed combination.

18. A method for using a personalized interactive communication system that uses a computer, the method comprising the steps of:
connecting an interactive communication device holder, having a sensor, to the computer;
placing an interactive communication device, comprising a tag and a person identifier, on or adjacent to the interactive communication device holder, wherein the interactive communication device is associated with a person via the person identifier;
having a plurality of applications automatically launch, wherein the plurality of applications is selected from the group consisting of a photo application, an e-mail application, a chat application, a music application, a video application, a RSS feed application, a calendar event application, a web-browser application and an aggregator;
allowing a user to access a graphical user interface for customizing the plurality of applications associated with the interactive communication device;
using the plurality of applications; and
allowing the user to determine whether the plurality of applications should terminate when the interactive communication device is removed from the interactive communication device holder.

19. The method of claim 18 wherein the person identifier is a photo frame having a picture of the person associated with the interactive communication device.

20. The method of claim 18 wherein the person identifier is a digital representation.

21. The method of claim 18 wherein the interactive communication device and the interactive communication device holder are a themed combination.

22. A personalized interactive communication system for use with a computer having a display screen, the personalized interactive communication system comprising:
an interactive communication device holder having a sensor for communicating information to the computer;
an interactive communication device comprising a tag and a person identifier, wherein the interactive communication device is associated with a person via the person identifier, wherein a user removably places the interactive communication device on or adjacent to the interactive communication device holder, such that when the sensor and the tag is within a distance apart, the tag communicates information to the sensor; and
a program installed within the computer for recognizing the information from the sensor, wherein the program launches at least one application selected from the group consisting of a photo application, an e-mail application, a chat application, a music application, a video application, a RSS feed application, a calendar event application, a web-browser application and an aggregator, wherein the at least one application has been associated with the tag.

23. The system of claim 22 further comprising a graphical user interface installed within the computer, wherein the graphical user interface allows a user to customize the interactive communication device to the at least one application.

24. The system of claim 22 wherein a user decides whether the at least one application is terminated once the sensor and the tag are greater than the distance apart.

25. The system of claim 22 wherein the interactive communication device holder is a platform, cradle or miniature object.

26. The system of claim 22 wherein the interactive communication device is a figurine, an action figure, a doll, a miniature sporting equipment, a pencil or a book.

27. The system of claim 22 wherein the interactive communication device and the interactive communication device holder are a themed combination.
